(19) United States
(12) Patent Application Publication
(10) Pub. No.: US 2018/0362552 A1
(43) Pub. Date: Dec. 20, 2018

(54) BETAINE-BASED SILICON COMPOUND, METHOD FOR PRODUCING SAME, HYDROPHILIC COATING LIQUID COMPOSITION, AND COATING FILM

(71) Applicant: KRI, Inc., Kyoto-shi, Kyoto (JP)

(72) Inventors: Masahiro Satoh, Kyoto (JP); Satsuki Kitajima, Kyoto (JP)

(73) Assignee: KRI, Inc., Kyoto-shi, Kyoto (JP)

(21) Appl. No.: 15/562,781

(22) PCT Filed: Mar. 25, 2016
(86) PCT No.: PCT/JP2016/059581

§ 371 Date: Sep. 28, 2017

(30) Foreign Application Priority Data
Apr. 15, 2015 (JP) 2015-083587

(51) Int. Cl. C07F 7/08; C09D 183/00; C09D 7/62

(52) U.S. Cl. CPC C07F 7/081; C07F 7/083; C09D 7/62; C09D 183/00

(57) ABSTRACT

There is provided a betaine-based silicon compound which exhibits the effect of hydrophilizating and defogging a surface. The betaine-based silicon compound is represented by formula (1). X¹₃₋ₘ(CH₃)ₘSi—R¹—(Y¹—R²)ₙ}ₒ—N⁺(R³)ₚ(R⁴)_{q}—Y²COO⁻(1) {In the formula: X¹ represents an alkoxy group with 1 to 5 carbon atoms or a halogen atom which may be identical to or different from one another; m represents 0 or 1; R¹ represents an alkylene group with 1 to 5 carbon atoms; Y¹ represents —NHCOO—, —NHCONH—, —S—, or —SO₂—; n represents 0 or 1; R² represents an alkylene group with 1 to 10 carbon atoms or —CH₂CH₂N⁺(CH₃)(Y²COO⁻)CH₂CH₂OCH₂CH₂—; o represents 1, 2 or 3; R³ and R⁴ represent an alkyl group with 1 to 5 carbon atoms which may be identical to or different from one another; Y² represents —CH₂— or the like; p and q represent 0 or 1; provided that o+p+q equals 3.

### TECHNICAL FIELD

The present invention relates to a betaine-based silicon compound having an effect of hydrophilizating and defogging a surface. More particularly, the present invention relates to a hydrophilic coating liquid composition with which a coating can be formed on a base material surface to impart the base material surface with hydrophilicity and a coating film prepared therewith.

### BACKGROUND ART

As surface characteristics required for a base material, defogging properties, antistatic properties, stain-proof properties, biocompatibility, and the like have been known.

In general, these surface characteristics are given to a base material by imparting hydrophilicity thereto.

As a polymer that can impart hydrophilicity to a base material, for example, a polymer of a phosphoryl group-containing methacrylic acid ester (for example, see Patent Document 1) and a polymer of N-methacryloyloxyethyl-N,N-dimethylammonium-α-N-methylcarboxybetaine (for example, see Patent Document 2) have been known. However, although these polymers are coatable on a plastic base material and have a certain level of durability, in the case of being applied on an inorganic base material such as a sheet of glass, these polymers have almost no interaction with the inorganic base material and there is a drawback that these polymers are poor in durability.

### PRIOR ART DOCUMENT

### Patent Documents

### Patent Document 1: JP-A-06-313009

### Patent Document 2: JP-A-2007-130194

### SUMMARY OF THE INVENTION

### Problems to be Solved by the Invention

The present invention has been made in view of the conventional art described above, and is aimed at providing a betaine-based silicon compound that is less liable to be separated from an inorganic base material even when brought into contact with water and that can be formed into a coating having an excellent hydrophilicity even on an inorganic base material surface; a hydrophilic coating liquid composition composed of a solution containing the betaine-based silicon compound; and a coating film prepared therewith.

### Solutions to the Problems

The present inventors have made earnest investigations while paying attention to problems in the conventional art as above, and consequently they have found out that the above-described problems can be solved by adopting a compound prepared by introducing a functional group which can form a covalent bond with an inorganic base material (for example, an alkoxysilyl group and the like) into a compound having a betaine group which interacts very strongly with water, and thus, the present invention has been completed.

That is, the present invention is characterized as having the following configuration and solves the above-described problems.

[1] A betaine-based silicon compound represented by the following formula (1):

{X¹₃₋ₘ(CH₃)ₘSi—R¹—(Y¹—R²)ₙ}ₒ—N(R³)ₚ(R⁴)_{q}—Y²COO⁻ (1)

{wherein X¹ represents an alkoxy group with 1 to 5 carbon atoms or a halogen atom, X¹s may be identical to or different from each other; m represents 0 or 1; R¹ represents an alkylene group with 1 to 5 carbon atoms; Y¹ represents —NHCOO—, —NHCONH—, —S—, or —SO—; n represents 0 or 1; R² represents an alkylene group with 1 to 10 carbon atoms which may contain an ether bond, an ester bond, or an amide bond or —CH₂CH₂N⁺(CH₃)(Y²COO⁻)CH₂CH₂OCH₂CH₂—; o represents 1, 2, or 3; R³ and R⁴ represent alkyl groups with 1 to 5 carbon atoms which may be identical to or different from each other; Y² represents —CH₂—, —CH₂CH₂—, or —CH₂C₆H₄—; p and q each represent 0 or 1; provided that o+p+q equals 3}.

[2] A hydrolysis product of the betaine-based silicon compound according to [1] described above.

[3] A hydrophilic coating liquid composition composed of a solution containing the betaine-based silicon compound and/or the hydrolysis product of the betaine-based silicon compound according to [1] and/or [2] described above.

[4] The hydrophilic coating liquid composition according to [3] described above, wherein a surface-active silane coupling agent being a reaction product between a surfactant represented by the following formula (2) and a silane coupling agent having a functional group reactive with an active hydrogen group in the formula (2) and/or a hydrolyzate thereof are/is further contained in the solution:

R⁵—X²—(CH₂CH₂O)ᵣ—Y³ (2)

{wherein R⁵ is an alkyl group with 1 to 20 carbon atoms (the alkyl group may contain a benzene ring and a double bond); X² is —O—, —COO—, or —CONH—; r is a natural number of 1 to 30; and Y³ represents a hydrogen atom or —CH₂COOH}.

[5] The hydrophilic coating liquid composition according to [3] or [4] described above, further containing at least one kind selected from the group of a metal alkoxide, a metal alkoxide oligomer, a metal oxide sol, and a metal oxide.

[6] A coating film obtained by applying the hydrophilic coating liquid composition according to any one of [3] to [5] described above and then curing the composition.

[7] A coating film obtained by performing dry coating with the betaine-based silicon compound according to [1] described above.

[8] A method for producing the betaine-based silicon compound represented by general formula (1) described above, the method comprising the step of causing a silane coupling agent represented by the following formula (3) and an alkali metal salt of a haloacetic acid compound represented by the following formula (4) to react with each other:

{X¹₃₋ₘ(CH₃)ₘSi—R¹—(Y¹—R^{2′})ₙ}ₒ—N(R³)ₚ(R⁴)_{q} (3)

{wherein X¹ represents an alkoxy group with 1 to 5 carbon atoms or a halogen atom, X¹s may be identical to or different from each other; m represents 0 or 1; R¹ represents an alkylene group with 1 to 5 carbon atoms; Y¹ represents —NHCOO—, —NHCONH—, —S—, or —SO₂—; n represents 0 or 1; R^{2′} represents an alkylene group with 1 to 10 carbon atoms which may contain an ether bond, an ester bond, or an amide bond or —CH₂CH₂N(CH₃)CH₂CH₂OCH₂CH₂—; o represents 1, 2, or 3; R³ and R⁴ represent alkyl groups with 1 to 3 carbon atoms which may be identical to or different from each other; p and q each represent 0 or 1; provided that o+p+q equals 3};

Z¹—Y⁵COOM (4)

{wherein Z¹ represents a halogen atom; Y⁵ represents —CH₂—, —CH₂CH₂—, or —CH₂C₆H₄—; and M represents an alkali metal atom}.

### Effects of the Invention

The present invention can provide a betaine-based silicon compound that has great hydrophilizating and defogging effects also on inorganic, carbon, and polymeric substrates, is high in durability, and is coatable thereon.

For example, the betaine-based silicon compound and hydrophilic coating liquid composition of the present invention are useful for imparting hydrophilicity and defogging properties to a surface of base materials such as a glass plate, a medical material, a biocompatible material, a cosmetic material, an optical material, a resin film, and a resin sheet.

### MODE FOR CARRYING OUT THE INVENTION

The betaine-based silicon compound of the present invention is characterized as being represented by the following formula (1):

{X¹₃₋ₘ(CH₃)ₘSi—R¹—(Y¹—R²)ₙ}ₒ—N⁺(R³)(R⁴)_{q}—Y²COO⁻ (1)

{wherein X¹ represents an alkoxy group with 1 to 5 carbon atoms or a halogen atom, X¹s may be identical to or different from each other; m represents 0 or 1; R¹ represents an alkylene group with 1 to 5 carbon atoms; Y¹ represents —NHCOO—, —NHCONH—, —S—, or —SO₂—; n represents 0 or 1; R² represents an alkylene group with 1 to 10 carbon atoms which may contain an ether bond, an ester bond, or an amide bond or —CH₂CH₂N⁺(CH₃)(Y²COO⁻)CH₂CH₂OCH₂CH₂—; o represents 1, 2, or 3; R³ and R⁴ represent alkyl groups with 1 to 5 carbon atoms which may be identical to or different from each other; Y² represents —CH₂—, —CH₂CH₂—, or —CH₂C₆H₄—; p and q each represent 0 or 1; provided that o+p+q equals 3}.

Moreover, the betaine-based silicon compound of the present invention is characterized as being a hydrolyzate of the betaine-based silicon compound represented by the foregoing formula (1).

Moreover, the present invention is directed to a method for producing a betaine-based silicon compound represented by general formula (1) described above, the method comprising the step of causing a silane coupling agent represented by the following formula (3) and an alkali metal salt of a haloacetic acid compound represented by the following formula (4) to react with each other:

{X¹₃₋ₘ(CH₃)ₘSi—R¹—(Y¹—R^{2′})ₙ}ₒ—N⁺(R³)ₚ(R⁴)_{q} (3)

{wherein X¹ represents an alkoxy group with 1 to 5 carbon atoms or a halogen atom, X¹s may be identical to or different from each other; m represents 0 or 1; R¹ represents an alkylene group with 1 to 5 carbon atoms; Y¹ represents —NHCOO—, —NHCONH—, —S—, or —SO₂—; n represents 0 or 1; R^{2′} represents an alkylene group with 1 to 10 carbon atoms which may contain an ether bond, an ester bond, or an amide bond or —CH₂CH₂N(CH₃)CH₂CH₂OCH₂CH₂—; o represents 1, 2, or 3; R³ and R⁴ represent alkyl groups with 1 to 3 carbon atoms which may be identical to or different from each other; p and q each represent 0 or 1; provided that o+p+q equals 3};

Z¹—Y⁵COOM (4)

{wherein Z¹ represents a halogen atom; Y⁵ represents —CH₂—, —CH₂CH₂—, or —CH₂C₆H₄—; and M represents an alkali metal atom}.

In formulas (1) and (3), examples of the alkoxy group with 1 to 5 carbon atoms as X¹ include a methoxy group, an ethoxy group, a n-propoxy group, and an iso-propoxy group and examples of the halogen atom as X¹ include a chlorine atom, a bromine atom, and the like. Among these, preferred are a methoxy group, an ethoxy group, and an iso-propoxy group which are alkoxy groups.

In formulas (1) and (3), examples of the alkylene group with 1 to 5 carbon atoms as R¹ include —CH₂—, —CH₂CH₂—, —CH₂CH₂CH₂—, —CH₂CH₂CH₂CH₂—, and —CH₂CH₂CH₂CH₂CH₂—. Among these, —CH₂CH₂CH₂— is preferred in consideration of easy availability of the raw material.

In formulas (1) and (3), Y¹ is —NHCOO—, —NHCONH—, —S—, or —SO₂—.

In formula (1), R² is an alkylene group with 1 to 10 carbon atoms which may contain an ether bond, an ester bond, or an amide bond or —CH₂CH₂N⁺(CH₃)(Y²COO⁻)CH₂CH₂OCH₂CH₂—, and Y² is —CH₂—, —CH₂CH₂— or —CH₂C₆H₄—.

Specific examples of R² include —CH₂—, —CH₂CH₂—, —CH₂CH₂CH₂—, —CH₂CH₂CH₂CH₂—, —CH₂CH₂CH₂CH₂CH₂—, —CH₂CH₂OCH₂CH₂CH₂—, —CH₂CH₂COOCH₂CH₂—, —CH₂CH(CH₃)COOCH₂CH₂—, —CH₂CH₂CONHCH₂CH₂CH₂—, —CH₂CH(CH₃)CONHCH₂CH₂CH₂—, —CH₂CH₂N⁺(CH₃)(CH₂COO⁻)CH₂CH₂OCH₂CH₂—, —CH₂CH₂N⁺(CH₃)(CH₂C₆H₄COO⁻)CH₂CH₂OCH₂CH₂—, and the like. Among these, preferred are —CH₂CH₂—, —CH₂CH₂CH₂—, —CH₂CH₂OCH₂CH₂—, —CH₂CH₂COOCH₂CH₂—, —CH₂CH(CH₃)COOCH₂CH₂—, —CH₂CH₂CONHCH₂CH₂CH₂—, —CH₂CH(CH₃)CONHCH₂CH₂CH₂—, and —CH₂CH₂N⁺(CH₃)(CH₂COO⁻)CH₂CH₂OCH₂CH₂—.

In formula (1), Y² is —CH₂—, —CH₂CH₂—, or —CH₂C₆H₄—, and preferred is —CH₂—.

In formula (2), examples of the alkyl group with 1 to 20 carbon atoms as R⁵ include a methyl group, an ethyl group, an octyl group, a decyl group, a dodecyl group, a tetradecyl group, a pentadecyl group, a hexadecyl group, a palmitoleyl group, a heptadecyl group, an octadecyl group, an oleyl group, and the like. Among these, preferred are a methyl group, a dodecyl group, and a heptadecyl group in consideration of the point of raw material availability.

In formula (2), X² is —O—, —COO—, or —CONH—.

r is a natural number of 1 to 30, and a natural number of 1 to 9 is preferred from the points of raw material availability and ease of handling of a liquid.

Y³ is a hydrogen atom or —CH₂COOH.

A compound represented by general formula (2) described above is a surfactant, and a compound commercially available as a surfactant can be used.

With regard to a commercially available surfactant which is composed of a compound represented by general formula (2) described above, usually, the number of ethylene oxides added is not a constant value, and as a result, the respective compounds are of uneven length of the ethylene oxide moiety, and the surfactant exists as a mixture of compounds differing in the number of ethylene oxides added.

In the case of a mixture of compounds represented by formula (2) described above, it is preferred that r in general formula (2) described above be 9 or less on average because the mixture is a liquid and is easy to be handled.

Specific examples of the compound represented by general formula (2) include compounds below.

CH₃O(CH₂CH₂O)₂H

CH₃O(CH₂CH₂O)₃H

CH₃O(CH₂CH₂O)₄H

CH₃O(CH₂CH₂O)₅H

CH₃O(CH₂CH₂O)₆H

C₁₂H₂₅O(CH₂CH₂O)₃CH₂COOH

C₁₂H₂₅O(CH₂CH₂O)₄CH₂COOH

C₁₂H₂₅O(CH₂CH₂O)₅CH₂COOH

C₁₃H₂₇O(CH₂CH₂O)₃CH₂COOH

C₁₂H₂₅O(CH₂CH₂O)₇H

C₁₂H₂₅O(CH₂CH₂O)₈H

C₁₂H₂₅O(CH₂CH₂O)₉H

C₁₂H₂₅O(CH₂CH₂O)₁₀H

C₁₂H₂₅O(CH₂CH₂O)₁₁H

C₁₇H₃₅COO(CH₂CH₂O)₉H

C₁₇H₃₃COO(CH₂CH₂O)₅H

C₁₇H₃₃COO(CH₂CH₂O)₉H

C₁₇H₃₃COO(CH₂CH₂O)₁₄H

C₁₇H₃₅CONHCH₂CH₂OH

The silane coupling agent having a functional group reactive with an active hydrogen group in a compound represented by formula (2) described above is a silane coupling agent having any functional group of an epoxy group, an isocyanate group, an acid anhydride group, and an amino group.

Then, preferred examples of the silane coupling agent reactive with an active hydrogen group in formula (2) include 3-glycidoxypropyltrimethoxysilane, 3-glycidoxypropyltriethoxysilane, 3-glycidoxypropylmethyldimethoxysilane, 3-glycidoxypropylmethyldiethoxysilane, 2-(3,4-epoxycyclohexyl)ethyltrimethoxysilane, 3-isocyanatepropyltriethoxysilane, 3-trimethoxysilylpropylsuccinic anhydride, 3-aminopropyltrimethoxysilane, 3-aminopropylmethyldimethoxysilane, and the like.

Specific examples of the surface-active silane coupling agent being a reaction product between the compound represented by formula (2) and the silane coupling agent having a functional group reactive with an active hydrogen group in formula (2) include compounds below.

CH₃—O—(CH₂CH₂O)₃CH₂CH(OH)CH₂OCH₂CH₂CH₂Si(OCH₃)₃

CH₃—O—(CH₂CH₂O)₃CH₂CH(OH)CH₂OCH₂CH₂CH₂Si(CH₃)(OCH₃)₂

C₁₂H₂₅—O—(CH₂CH₂O)₇CH₂CH(OH)CH₂OCH₂CH₂CH₂Si(OCH₃)₃

C₁₂H₂₅—O—(CH₂CH₂O)₇CH₂COOCH₂CH(OH)CH₂OCH₂CH₂CH₂Si(OCH₃)₃

C₁₂H₂₅—O—(CH₂CH₂O)₈CH—COOCH₂CH(OH)CH₂OCH₂CH₂CH₂Si(OCH₃)₃

C₁₂H₂₅—O—(CH₂CH₂O)₉CH₂COOCH₂CH(OH)CH₂OCH₂CH₂CH₂Si(OCH₃)₃

C₁₂H₂₅—O—(CH₂CH₂O)₈CH₂CONHCH₂CH₂CH₂Si(OCH₃)₃

C₁₂H₂₅—O—(CH₂CH₂O)₉CH₂CONHCH₂CH₂CH₂Si(OCH₃)₃

CH₃—O—(CH₂CH₂O)₃COCH₂CH(COOH)CH₂CH₂CH₂Si(OCH₃)₃

CH₃—O—(CH₂CH₂O)₃COCH(CH₂COOH)CH₂CH₂CH₂Si(OCH₃)₃

C₁₂H₂₅—O—(CH₂CH₂O)₇COCH₂CH(COOH)CH₂CH₂CH₂Si(OCH₃)₃

C₁₂H₂₅—O—(CH₂CH₂O)₈COCH(CH₂COOH)CH₂CH₂CH₂Si(OCH₃)₃

C₁₇H₃₅—COO—(CH₂CH₂O)₉COCH₂CH(COOH)CH₂CH₂CH₂Si(OCH₃)₃

C₁₇H₃₃—COO—(CH₂CH₂O)₅COCH(CH₂COOH)CH₂CH₂CH₂Si(OCH₃)₃

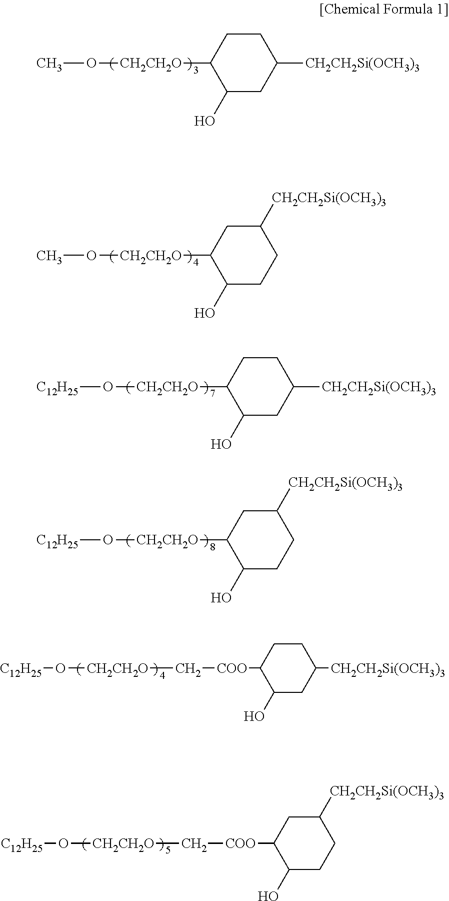

In formula (3), examples of R^{2′} include —CH₂—, —CH₂CH₂—, —CH₂CH₂CH₂—, —CH₂CH₂CH₂CH₂—, —CH₂CH₂CH₂CH₂CH₂—, —CH₂CH₂OCH₂CH₂—, —CH₂CH₂COOCH₂CH₂—, —CH₂CH(CH₃)COOCH₂CH₂—, —CH₂CH₂CONHCH₂CH₂CH—, —CH₂CH(CH₃)CONHCH₂CH₂CH₂—, —CH₂CH₂N(CH₃)CH₂CH₂OCH₂CH₂—, and the like. Among these, preferred are —CH₂CH₂—, —CH₂CH₂CH₂—, —CH₂CH₂OCH₂CH₂—, —CH₂CH₂COOCH₂CH₂—, —CH₂CH(CH₃)COOCH₂CH₂—, —CH₂CH₂CONHCH₂CH₂CH₂—, —CH₂CH(CH₃)CONHCH₂CH₂CH₂—, and —CH₂CH₂N(CH₃)CH₂CH₂OCH₂CH₂—.

In formulas (1) and (3), examples of the alkyl group with 1 to 3 carbon atoms as each of R³ and R⁴ include a methyl group, an ethyl group, and the like. Among these, preferred is a methyl group.

In formula (4), examples of the halogen atom represented as Z¹ include a fluorine atom, a chlorine atom, a bromine atom, an iodine atom, and the like. Among these, preferred are a chlorine atom and a bromine atom, and especially preferred is a chlorine atom.

In formula (4), Y⁵ is —CH₂—, —CH₂CH₂—, or —CH₂C₆H₄—, and preferred is —CH₂—.

In formula (4), M is an alkali metal atom, and examples thereof include a lithium ion, a sodium ion, a potassium ion, a cesium ion, and the like. Among these, preferred are a sodium ion and a potassium ion, and from the point of raw material availability, a sodium ion is especially preferred.

Specific examples of the betaine-based silicon compound of the present invention represented by formula (1) include compounds below.

In this connection, in the following formulas, p represents 1, 2, or 3.

(CH₃O)₃SiCH₂CH₂CH₂N⁺(CH₃)₂CH₂COO⁻ (1-1)

(CH₃O)₂(CH₃)SiCH₂CH₂CH₂N⁺(CH₃)₂CH₂COO⁻ (1-2)

(CH₃O)₃₋ₚ(C₂H₅O)ₚSiCH₂CH₂CH₂N⁺(CH₃)₂CH₂COO⁻ (1-3)

(CH₃O)₃SiCH₂CH₂CH₂N⁺(CH₃)₂CH₂CH₂COO⁻ (1-4)

(CH₃O)₂(CH₃)SiCH₂CH₂CH₂CH₂N⁺(CH₃)₂CH₂CH₂COO⁻ (1-5)

(CH₃O)₃₋ₚ(C₂H₅O)ₚSiCH₂CH₂CH₂N⁺(CH₃)₂CH₂CH₂COO⁻ (1-6)

(CH₃O)₃SiCH₂CH₂CH₂N⁺(CH₃)₂CH₂C₆H₄COO⁻ (1-7)

(CH₃O)₂(CH₃)SiCH₂CH₂CH₂N⁺(CH₃)₂CH₂CH₄COO⁻ (1-8)

(CH₃O)₃₋ₚ(C₂H₅O)ₚSiCH₂CH₂CH₂N⁺(CH₃)₂CH₂C₆H₄COO⁻ (1-9)

(CH₃O)₃₋ₚ(iso-C₃H₇O)ₚSiCH₂CH₂CH₂N⁺(CH₃)₂CH₂COO⁻ (1-10)

(C₂H₅O)₃SiCH₂CH₂CH₂NHCOOCH₂CH₂N⁺(CH₃)₂CH₂COO⁻ (1-11)

(C₂H₅O)₂(CH₃)SiCH₂CH₂CH₂NHCOOCH₂CH₂N⁺(CH₃)₂CH₂COO⁻ (1-12)

(C₂H₅O)₃₋ₚ(iso-C₃H₇O)ₚSiCH₂CH₂CH₂NHCOOCH₂CH₂N⁺(CH₃)₂CH₂COO⁻ (1-13)

(C₂H₅O)₂(CH₃)SiCH₂CH₂CH₂NHCOOCH₂CH₂CH₂N⁺(CH₃)₂CH₂COO⁻ (1-14)

(C₂H₅O)₃₋ₚ(iso-C₃H₇O)ₚSiCH₂CH₂CH₂NHCOOCH₂CH₂CH₂N⁺(CH₃)₂CH₂COO⁻ (1-15)

(C₂H₅O)₃SiCH₂CH₂CH₂NHCOOCH₂CH₂CH₂N⁺(CH₃)₂CH₂COO⁻ (1-16)

(C₂H₅O)₂(CH₃)SiCH₂CH₂CH₂NHCOOCH₂CH₂CH₂CH—N⁺(CH₃)₂CH₂COO⁻ (1-17)

(C₂H₅O)₃₋ₚ(iso-C₃H₇O)ₚSiCH₂CH₂CH₂NHCOOCH₂CH₂CH₂CH₂N⁺(CH₃)₂CH₂COO⁻ (1-18)

(C₂H₅O)₃SiCH₂CH₂CH₂NHCOOCH₂CH₂OCH₂CH₂N⁺(CH₃)₂CH₂COO⁻ (1-19)

(C₂H₅O)₂(CH₃)SiCH₂CH₂CH₂NHCOOCH₂CH₂OCH₂CH₂N⁺(CH₃)₂CH₂COO⁻ (1-20)

(C₂H₅O)₃₋ₚ(iso-C₃H₇O)ₚSiCH₂CH₂CH₂NHCOOCH₂CH₂OCH₂CH₂N+(CH₃)₂CH₂COO⁻ (1-21)

(C₂H₅O)₃SiCH₂CH₂CH₂NHCONHCH₂CH₂N⁺(CH₃)₂CH₂COO⁻ (1-22)

(C₂H₅O)₃SiCH₂CH₂CH₂NHCONHCH₂CH₂CH₂N⁺(CH₃)₂CH₂COO⁻ (1-23)

(C₂H₅O)₃SiCH₂CH₂CH₂NHCONHCH₂CH₂N⁺(CH₃)₂CH₂CH₂COO⁻ (1-24)

(C₂H₅O)₃SiCH₂CH₂CH₂NHCONHCH₂CH₂CH₂N⁺(CH₃)₂CH₂CH₂COO⁻ (1-25)

(C₂H₅O)₃SiCH₂CH₂CH₂NHCONHCH₂CH₂N⁺(CH₃)₂CH₂C₆H₄COO⁻ (1-26)

(C₂H₅O)₃SiCH₂CH₂CH₂NHCONHCH₂CH₂CH₂N⁺(CH₃)₂C₆H₄CH₂COO⁻ (1-27)

(CH₃O)₃SiCH₂CH₂CH₂SCH₂CH₂CH₂N⁺(CH₃)₂CH₂COO⁻ (1-28)

(CH₃O)₂(CH₃)SiCH₂CH₂CH₂SCH₂CH₂CH₂N⁺(CH₃)₂CH₂COO⁻ (1-29)

(CH₃O)₃₋ₚ(C₂H₅O)ₚSiCH₂CH₂CH₂SCH₂CH₂CH₂N⁺(CH₃)₂CH₂COO⁻ (1-30)

(CH₃O)₃₋ₚ(iso-C₃H₇O)ₚSiCH₂CH₂CH₂SCH₂CH₂CH₂N⁺(CH₃)₂CH₂COO⁻ (1-31)

(CH₃O)₃₋ₚ(C₂H₅O)ₚSiCH₂CH₂CH₂S(CH₃)CH₂CH₂N⁺(CH₃)₂CH₂COO⁻ (1-32)

(CH₃O)₃₋ₚ(iso-C₃H₇O)ₚSiCH₂CH₂CH₂S(CH₃)CH₂CH₂N⁺(CH₃)₂CH₂COO⁻ (1-33)

(CH₃O)₃SiCH₂CH₂CH₂SCH₂CH₂COOCH₂CH₂N⁺(CH₃)₂CH₂COO⁻ (1-34)

(CH₃O)₂(CH₃)SiCH₂CH₂CH₂SCH₂CH₂COOCH₂CH₂N⁺(CH₃)₂CH₂COO⁻ (1-35)

(CH₃O)₃₋ₚ(C₂H₅O)ₚSiCH₂CH₂CH₂SCH₂CH₂COOCH₂CH₂CH₂N⁺(CH₃)₂CH₂COO⁻ (1-36)

(CH₃O)₃SiCH₂CH₂CH₂SCH₂CH(CH₃)COOCH₂CH₂N⁺(CH₃)₂CH₂COO⁻ (1-37)

(CH₃O)₂(CH₃)SiCH₂CH₂CH₂SCH₂CH(CH₃)COOCH₂CH₂N⁺(CH₃)₂CH₂COO⁻ (1-38)

(CH₃O)₃₋ₚ(C₂H₅O)ₚSiCH₂CH₂CH₂SCH₂CH(CH₃)COOCH₂CH₂N⁺(CH₃)₂CH₂COO⁻ (1-39)

(CH₃O)₃SiCH₂CH₂CH₂SCH₂CH₂CONHCH₂CH₂CH₂N⁺(CH₃)₂CH₂COO⁻ (1-40)

(CH₃O)₂(CH₃)SiCH₂CH₂CH₂SCH₂CH₂CONHCH₂CH₂CH₂N⁺(CH₃)₂CH₂COO⁻ (1-41)

(CH₃O)₃₋ₚ(C₂H₅O)ₚSiCH₂CH₂CH_SCH₂CH₂CONHCH₂CH₂CH₂N⁺(CH₃)₂CH₂COO⁻ (1-42)

(CH₃O)₃SiCH₂CH₂CH₂SCH₂CH(CH₃)CONHCH₂CH₂CH₂N⁺(CH₃)₂CH₂COO⁻ (1-43)

(CH₃O)₂(CH₃)SiCH₂CH₂CH₂SCH₂CH(CH₃)CONHCH₂CH₂CH₂N⁺(CH₃)₂CH₂COO⁻ (1-44)

(CH₃O)₃₋ₚ(C₂H₅O)ₚSiCH₂CH₂CH₂SCH₂CH(CH₃)CONHCH₂CH₂CH₂N⁺(CH₃)₂CH₂COO⁻ (1-45)

(C₂H₅O)₃SiCH₂CH₂CH₂NHCOOCH₂CH₂N⁺(CH₃)(CH₂COO⁻)CH₂CH₂OCH₂CH₂N⁺(CH₃)₂CH₂COO⁻ (1-46)

{(C₂H₅O)₃SiCH₂CH₂CH₂NHCOOCH₂CH₂}₂N⁺(CH₃)CH₂COO⁻ (1-47)

{(C₂H₅O)₃SiCH₂CH₂CH₂NHCOOCH₂CH₂}₃N⁺CH₂COO⁻ (1-48)

A hydrolysis product of the betaine-based silicon compound of the present invention refers to a product in which at least one alkoxy group of the above-described betaine-based silicon compound is hydrolyzed to be made into a hydroxyl group (—OH).

More specifically, the betaine-based silicon compound of the present invention is obtained by the following production method.

That is, the betaine-based silicon compound can be obtained by causing an alkali metal salt of a haloacetic acid compound represented by formula (4)(for example, an alkali metal salt of a halocarboxylic acid compound) to react with a silane coupling agent represented by formula (3)(for example, a dimethylamino group-containing silicon compound).

By using an alkali metal salt, a halogenated alkali salt generated at the time of being made into betaine can be easily removed by filtration or the like because the halogenated alkali salt as a precipitate transfers to the outside of the reaction system.

Examples of a solvent used for the reaction include nonaqueous solvents (alcohol-based solvents: methanol, ethanol, isopropanol, n-butanol, tert-butanol, pentanol, ethylene glycol, propylene glycol, propylene glycol monomethyl ether, 1,4-butanediol, and the like, ether-based solvents: diethyl ether, tetrahydrofuran, dioxane, and the like, ketone-based solvents: acetone, methyl ethyl ketone, and the like, aprotic solvents: dimethyl sulfoxide, N,N-dimethylformamide, and the like, aromatic hydrocarbon-based solvents: toluene, xylene, and the like), a mixed solvent thereof, and the like.

Among these, preferred are alcohol-based solvents and one kind or two or more kinds of these solvents can be used. Especially preferred are methanol, ethanol, isopropanol, and propylene glycol monomethyl ether.

The reaction temperature is preferably a boiling point of a solvent used or a temperature higher than the boiling point, and the reaction may be performed under elevated pressure in order to make the reaction temperature higher than or equal to the boiling point.

The reaction time is usually 6 hours to 36 hours, preferably 8 hours to 36 hours, and especially preferably 8 hours to 24 hours.

As a dialkylamino group-containing silicon compound being a raw material, a commercially available one can be directly used or a carbamate group-containing silicon compound that can be obtained by causing an isocyanate group-containing silicon compound (for example, 3-isocyanatepropyltriethoxysilane, and the like) to react with a commercially available dialkylamino group-containing alcohol {for example: 2-dimethylaminoethanol, 3-dimethylaminopropanol, 4-dimethylaminobutanol, 2-dimethylaminoethoxyethanol, N,N,N′-trimethyl-N′-(2-hydroxyethyl)-bis(2-aminoethylether), and the like} can be used.

Moreover, a thioether group-containing silicon compound that can be obtained by causing a thiol group-containing silicon compound (for example, 3-mercaptopropyltrimethoxy, 3-mercaptopropylmethyldimethoxysilane, and the like) to react with dimethylallylamine, 2-(dimethylamino)ethyl acrylate, 2-(dimethylamino)ethyl methacrylate, N-[3-(dimethylamino)propyl]acrylamide, N-[3-(dimethylamino)propyl]methacrylamide, and the like can be used.

In the above-described reaction, a solvent may be used or may not be used.

At the time of using a solvent in the above-described reaction, examples of the solvent used include nonaqueous solvents (ester-based solvents: for example, methyl acetate, ethyl acetate, butyl acetate, and the like, ether-based solvents: for example, diethyl ether, tetrahydrofuran, 1,2-dimethoxyethane, dioxane, and the like, ketone-based solvents: for example, acetone, methyl ethyl ketone, and the like, aprotic solvents: for example, dimethyl sulfoxide, N,N-dimethylformamide, and the like, aromatic hydrocarbon-based solvents: for example, toluene, xylene, and the like), a mixed solvent thereof, and the like.

Among these, non-solvent, an ester-based solvent (for example, ethyl acetate or butyl acetate) or an ether-based solvent (for example, tetrahydrofuran, 1,2-dimethoxyethane, or the like) is preferred.

Moreover, with regard to the reaction temperature, the reaction can be performed at 0° C. to 200° C. and the reaction temperature preferably lies within the range of room temperature to 150° C. and especially preferably lies within the range of room temperature to 100° C.

Moreover, tin-based catalysts (for example, dibutyltin dilaurate, and the like) may be used for the reaction between a dimethylamino group-containing alcohol and an isocyanate group-containing silicon compound, and azo-based catalysts (for example, azobisisobutyronitrile, and the like) may be used for the reaction between dimethylallylamine, 2-(dimethylamino)ethyl acrylate, 2-(dimethylamino)ethyl methacrylate, N-[3-(dimethylamino)propyl]acrylamide, N-[3-(dimethylamino)propyl]methacrylamide, or the like and a thiol group-containing silicon compound.

The hydrophilic coating liquid composition of the present invention is characterized as being composed of a solution containing the betaine-based silicon compound according to [1] described above and/or the hydrolysis product of the betaine-based silicon compound.

Moreover, in addition to the betaine-based silicon compound and/or the hydrolysis product of the betaine-based silicon compound according to [1] and [2] described above, at least one kind of a surface-active silane coupling agent and/or a hydrolyzate thereof according to [4] described above may be contained in the hydrophilic coating liquid composition of the present invention.

The addition amount of the above-described surface-active silane coupling agent and/or a hydrolyzate thereof is usually 0.001 to 5.0 g and preferably 0.01 to 3.0 g per 1.0 g of the betaine-based silicon compound.

When the amount lies within the above-described range, film formability is improved, and moreover, hydrophilicity and defogging properties are enhanced.

Furthermore, at least one kind of a metal alkoxide, a metal alkoxide oligomer, a metal oxide sol, and a metal oxide may be contained in the hydrophilic coating liquid composition of the present invention.

Examples of the metal of the metal alkoxide described above include silicon, titanium, zirconium, aluminum, and the like. Among these, preferred are silicon, titanium, and zirconium, and especially preferred is silicon.

Examples of the alkoxy group of the metal alkoxide described above include alkoxy groups with 1 to 10 carbon atoms (a methoxy group, an ethoxy group, a n-propoxy group, an iso-propoxy group, a n-butoxy group, a tert-butoxy group, and the like). Among these, preferred are a methoxy group, an ethoxy group, an iso-propoxy group, a n-butoxy group, and a tert-butoxy group, and further preferred are a methoxy group and an ethoxy group.

In this connection, the alkoxy group described above may be partially substituted by other organic groups {a methyl group, a vinyl group, a 2-(3,4-epoxycyclohexyl) group, a 3-glycidyl group, a 3-glycidoxypropyl group, a p-styryl group, a 3-methacryloxypropyl group, a 3-acryloxypropyl group, an N-2-(aminoethyl)-3-aminopropyl group, a 3-aminopropyl group, a N-phenyl-3-aminopropyl group, a N-(vinylbenzyl)-2-aminoethyl-3-aminopropyl group, a 3-ureidopropyl group, a 3-isocyanatepropyl group (also including a blocked isocyanate group), a 3-chloropropyl group, a β-diketonate group (2,4-pentadionate group), and the like}.

Specific examples of a compound in which the alkoxy group described above is partially substituted by other organic groups include the following.

CH₃Si(OCH₃)₃

CH₃Si(OC₂H₅)₃

C₈H₁₇Si(OCH₃)₃

C₈H₁₇Si(OC₂H₅)₃

C₁₈H₃₇Si(OCH₃)₃

C₁₈H₃₇Si(O₂H₅)₃

CH₂═CHSi(OCH₃)₃

CH₂═CHSi(OC₂H₅)₃

H₂NCH₂CH₂CH₂Si(OCH₃)₃

H₂NCH₂CH₂CH₂Si(OC₂H₅)₃

ClCH₂CH₂CH₃Si(OCH₃)₃

SHCH₂CH₂CH₂Si(OCH₃)₃

SHCH₂CH₂CH₂Si(CH₃)(OCH₃)₂

CH₂═CHCOOCH₂C₂CH₂Si(OCH₃)₃

CH₂═C(CH₃)COOCH₂CH₂CH₂Si(OCH₃)₃

C₆H₅Si(OCH₃)₃

C₆H₅Si(OC₂H₃)₃

(CH₃)₃COCOCH₂CH₂SCH₂CH₂CH₂Si(OCH₃)₃

(CH₃)₃COCOCH₂CH₂SCH₂CH₂CH₂(CH₃)Si(OCH₃)₂ [Chemical Formula 2]

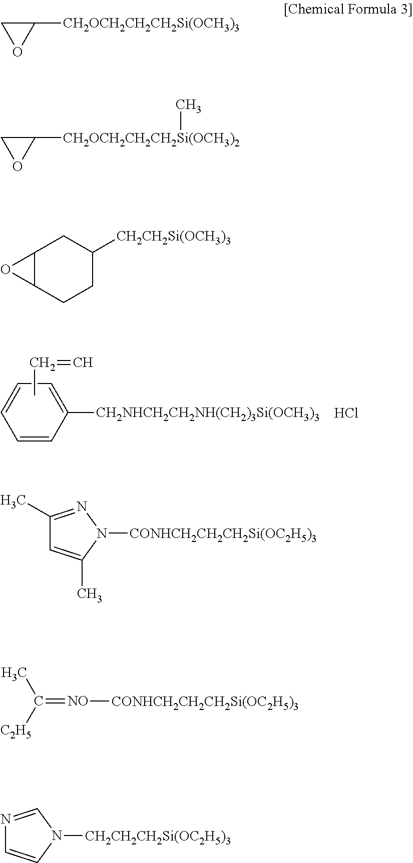

Examples of the metal alkoxide oligomer described above include COLCOAT series (Methyl Silicate 51, Methyl Silicate 53A, Ethyl Silicate 40, Ethyl Silicate 48, EMS485, SS101, SS-C1, HAS-5, HAS-1, HAS-10, COLCOAT P, COLCOAT 103-X, and the like) available from COLCOAT CO., LTD., and the like.

Examples of the metal oxide sol described above include colloidal silicas {SNOWTEX (ST-XS, ST-30, ST-50, ST-NXS, ST-N, ST-OXS, ST-O, ST-C, ST-AK, and the like), ORGANOSILICASOL (a methanol-dispersed standard type, a methanol-dispersed L type, an isopropyl alcohol-dispersed standard type, an isopropyl alcohol-dispersed L type, and the like), Aluminasol (AS-100, AS-200, AS-520, AS-550, and the like)} available from Nissan Chemical Industries, Ltd., alumina sols (Alumisol-10A, Alumisol-CSA-110AD, Alumisol-10D, and the like) available from Kawaken Fine Chemicals Co., Ltd., hollow nano silica sols (for example, THRULYA and the like) available from JGC Catalysts and Chemicals Ltd., modified metal oxide sols described in JP 5750436 B2, Japanese Patent Application No. JP 2015-200819, and Japanese Patent Application No. JP 2015-200828, and the like.

Examples of the metal oxide described above include fumed silicas (for example: AEROSIL 90, AEROSIL 130, AEROSIL 150, AEROSIL 200, AEROSIL 255, AEROSIL 300, AEROSIL 380, AEROXIDE Alu 130, AEROXIDE TiO₂ P 25, and the like) available from NIPPON AEROSIL CO., LTD., hollow nano silicas (for example, SiliNax (registered trademark) and the like) available from Nittetsu Mining Co., Ltd., hollow nano silicas (for example, THRULYA and the like) available from JGC Catalysts and Chemicals Ltd., and the like.

Among these, preferred are a metal alkoxide in which the alkoxy group may be partially substituted by other organic groups, a metal oxide sol, and a metal alkoxide oligomer.

The addition amount of each of the above-described metal alkoxide in which the alkoxy group may be partially substituted by other organic groups, the metal oxide sol, and the metal alkoxide oligomer is usually 0.01 to 5.0 g and preferably 0.1 to 3.0 g per 1.0 g of the betaine-based silicon compound.

When the amount lies within the above-described range, characteristics possessed by the betaine-based silicon compound (for example, hydrophilicity, dispersibility, adhesion to a base material, curing characteristics, and the like) can be further exerted, and moreover, film formability is also improved.

Subsequently, a preparation method of a hydrophilic coating liquid composition will be described.

The hydrophilic coating liquid composition of the present invention can be obtained by hydrolyzing the betaine-based silicon compound of the present invention in a water-soluble solvent: for example, an alcohol-based solvent: methanol, ethanol, isopropanol, n-butanol, tert-butanol, pentanol, ethylene glycol, propylene glycol, 1,4-butanediol, or the like, an ether-based solvent: tetrahydrofuran, dioxane, or the like, a ketone-based solvent: acetone, methyl ethyl ketone, or the like, an aprotic solvent: dimethyl sulfoxide, N,N-dimethylformamide, or the like, a mixed solvent thereof, or the like.

The temperature at the time of hydrolyzing the betaine-based silicon compound lies within the range of room temperature to a boiling point of a water-soluble solvent used, and is preferably the boiling point.

Moreover, at the time of hydrolysis, an acid (for example, acetic acid, hydrochloric acid, nitric acid, or the like) or a base (sodium hydroxide, potassium hydroxide, lithium hydroxide, potassium nitrate, calcium nitrate, barium nitrate, or the like) may be added.

The reaction time required for the hydrolysis is usually 30 minutes to 48 hours and preferably 2 to 24 hours.

Furthermore, for the purpose of enhancing the workability (handleability, coatability, and the like), a dilution solvent may be contained in the hydrophilic coating liquid composition of the present invention. No restriction is put on the dilution solvent as long as the solvent does not react with the hydrophilic coating liquid composition of the present invention and can dissolve and/or disperse the components of the composition, and examples thereof include ether-based solvents (tetrahydrofuran, dioxane, and the like), alcohol-based solvents (methyl alcohol, ethyl alcohol, n-propyl alcohol, iso-propyl alcohol, n-butyl alcohol, propylene glycol monomethyl ether, and the like), ester-based solvents (ethyl acetate, butyl acetate, and the like), ketone-based solvents (acetone, methyl ethyl ketone, methyl isobutyl ketone, and the like), aprotic solvents (N,N-dimethylformamide, N,N-dimethylacetamide, N-methylpyrrolidone, dimethyl sulfoxide, and the like), water, and the like.

When the composition contains the diluting solvent, the content of the diluting solvent is, for example, such an amount that the weight percentage of the betaine-based silicon compound of the present invention is 0.005 to 15% by weight (preferably 0.01 to 10% by weight, especially preferably 0.01 to 7.5% by weight) to the whole of the solvents.

When these compounds are hydrolyzed in a water-soluble solvent to be coated onto an inorganic material, specific examples of a functional group that exists on a surface of the inorganic base material include groups represented by the following structural formulas.

(—O—)₃SiCH₂CH₂CH₂N⁺(CH₃)₂CH₂COO⁻

(—O—)₃SiCH₂CH₂CH₂N⁺(CH₃)₂CH₂CH₂COO⁻

(—O—)₃SiCH₂CH₂CH₂N⁺(CH₃)₂CH₂C₆H₄COO⁻

(—O—)₃SiCH₂CH₂CH₂NHCOOCH₂CH₂N⁺(CH₃)₂CH₂COO⁻

(—O—)₃SiCH₂CH₂CH₂NHCOOCH₂CH₂CH₂N⁺(CH₃)₂CH₂COO⁻

(—O—)₃SiCH₂CH₂CH₂NHCOOCH₂CH₂CH₂CH₂N⁺(CH₃)₂CH₂COO⁻

(—O—)₃SiCH₂CH₂CH₂NHCONHCH₂CH₂N⁺(CH₃)₂CH₂COO⁻

(—O—)₃SiCH₂CH₂CH₂NHCONHCH₂CH₂CH₂N⁺(CH₃)₂CH₂COO⁻

(—O—)₃SiCH₂CH₂CH₂NHCOOCH₂CH₂OCH₂CH₂N⁺(CH₃)₂CH₂COO⁻

(—O—)₃SiCH₂CH₂CH₂SCH₂CH₂COOCH₂CH₂N⁺(CH₃)₂CH₂COO⁻

(—O—)₃SiCH₂CH₂CH₂SCH₂CH(CH₃)COOCH₂CH₂N⁺(CH₃)₂CH₂COO⁻

(—O—)₃SiCH₂CH₂CH₂SO₂CH₂CH₂COOCH₂CH₂N⁺(CH₃)₂CH₂COO⁻

(—O—)₃SiCH₂CH₂CH₂SO₂CH₂CH(CH₃)COOCH₂CH₂N⁺(CH₃)₂CH₂COO⁻

(—O—)₃SiCH₂CH₂CH₂SCH₂CH₂CONHCH₂CH₂CH₂CH₂N⁺(CH₃)₂CH₂COO⁻

(—O—)₃SiCH₂CH₂CH₂SCH₂CH(CH₃)CONHCH₂CH₂CH₂N⁺(CH₃)₂CH₂COO⁻

(—O—)₃SiCH₂CH₂CH₂SO₂CH₂CH₂CONHCH₂CH₂CH₂N⁺(CH₃)₂CH₂COO⁻

(—O—)₃SiCH₂CH₂CH SO₂CH₂CH(CH₃)CONHCH₂CH₂N⁺(CH₃)₂CH₂COO⁻

(—O—)₃SiCH₂CH₂CH₂SCH₂CH₂CH₂N⁺(CH₃)₂CH₂COO⁻

(—O—)₃SiCH₂CH₂CH₂SO₂CH₂CH₂CH₂N⁺(CH₃)₂CH₂COO⁻

(—O—)₃SiCH₂CH₂CH₂SO₂(CH₃)CH₂CH₂N⁺(CH₃)₂CH₂COO⁻

(—O—)₃SiCH₂CH₂CH₂SO₂(CH₃)CH₂CH₂N⁺(CH₃)₂CH₂COO⁻

(—O—)₂(CH₃)SiCH₂CH₂CH₂N⁺(CH₃)₂CH₂COO⁻

(—O—)₂(CH₃)SiCH₂CH₂CH₂NHCOOCH₂CH₂N⁺(CH₃)₂CH₂COO⁻

(—O—)₂(CH₃)SiCH₂CH₂CH₂NHCOOCH₂CH₂CH₂N⁺(CH₃)₂CH₂COO⁻

(—O—)₂(CH₃)SiCH₂CH₂CH₂NHCOOCH₂CH₂CH₂CH₂N⁺(CH₃)₂CH₂COO⁻

(—O—)₂(CH₃O)SiCH₂CH₂CH₂NHCOOCH₂CH₂OCH₂CH₂N⁺(CH₃)₂CH₂COO⁻

(—O—)₂(CH₃)SiCH₂CH₂CH₂SCH₂CH₂CH₂N⁺(CH₃)₂CH₂COO⁻

(—O—)₂(CH₃)SiCH₂CH₂CH₂SO₂CH₂CH₂CH₂N⁺(CH₃)₂CH₂COO⁻

(—O—)₂(CH₃)SiCH₂CH₂CH₂S(CH₃)CH₂CH₂N⁺(CH₃)₂CH₂COO⁻

(—O—)₂(CH₃)SiCH₂CH₂CH₂SO₂(CH₃CH₂CH₂N⁺(CH₃)₂CH₂COO⁻

(—O—)₂(CH₃)SiCH₂CH₂CH₂SCH₂CH₂COOCH₂CH₂N⁺(CH₃)₂CH₂COO⁻

(—O—)₂(CH₃)SiCH₂CH₂CH₂SCH₂CH(CH₃)COOCH₂CH₂N⁺(CH₃)₂CH₂COO⁻

(—O—)₂(CH₃)SiCH₂CH₂CH₂SO₂CH₂CH₂COOCH₂CH₂N⁺(CH₃)₂CH₂COO⁻

(—O—)₂(CH₃)SiCH₂CH₂CH₂SO₂CH₂CH(CH₃)COOCH₂CH₂N⁺(CH₃)₂CH₂COO⁻

(—O—)₂(CH₃)SiCH₂CH₂CH₂SCH₂CH₂CONHCH₂CH₂CH₂N⁺(CH₃)₂CH₂COO⁻

(—O—)₂(CH₃)SiCH₂CH₂CH₂SCH₂CH(CH₃)CONHCH₂CH₂CH₂N⁺(CH₃)₂CH₂COO⁻

(—O—)₂(CH₃)SiCH₂CH₂CH₂SO₂CH₂CH₂CONHCH₂CH₂CH₂N⁺(CH₃)₂CH₂COO⁻

(—O—)₂(CH₃)SiCH₂CH₂CH₂SO₂CH₂CH(CH₃)CONHCH₂CH₂CH₂N⁺(CH₃)₂CH₂COO⁻

(—O—)₃SiCH₂CH₂CH₂NHCOOCH₂CH₂N⁺(CH₃)₂CH₂COO^{-)CH}₂CH₂OCH₂CH₂N⁺(CH₃)₂CH₂COO⁻

{(—O—)₃SiCH₂CH₂CH₂NHCONHCH₂CH₂}₂N⁺(CH₃)CH₂COO⁻

{(—O—)₃SiCH₂CH₂CH₂NHCONHCH₂CH₂}₃N⁺CH₂COO⁻

The hydrophilic coating liquid composition of the present invention needs only to contain the above-described compound, but other than the above-described compound, one or more kinds of a surface-active silane coupling agent, a metal alkoxide, a metal alkoxide oligomer, a metal oxide sol, a metal oxide, and the like may be contained therein.

The surface-active silane coupling agent, the metal alkoxide, the metal alkoxide oligomer, the metal oxide sol, the metal oxide, and the like described above may be above added to a water-soluble solvent together with the betaine-based silicon compound of the present invention to be hydrolyzed, may be added simultaneously with the betaine-based silicon compound at the time of hydrolysis, and moreover, may be added after the betaine-based silicon compound is hydrolyzed in a water-soluble solvent. Preferably, it is good to add them before the betaine-based silicon compound is hydrolyzed or simultaneously with the betaine-based silicon compound at the time of hydrolysis.

In order to promote curing, the hydrophilic coating liquid composition of the present invention may be added with a metal salt or a base.

Examples of the metal salt include hydroxides (lithium hydroxide, sodium hydroxide, potassium hydroxide, cesium hydroxide, magnesium hydroxide, calcium hydroxide, and the like), acetates (lithium acetate, sodium acetate, potassium acetate, silver acetate, and the like), nitrates (calcium nitrate, barium nitrate, and the like), and metal oxides (silver oxide and the like).

Examples of the base include ammonia, trimethylamine, triethylamine, tetramethylammonium hydroxide, tetraethylammonium hydroxide, and the like.

The addition amount of the metal salt or the base is usually 0.001 to 50% by weight, preferably 0.005 to 20% by weight, and more preferably 0.01 to 10% by weight relative to the amount of the modified metal oxide sol.

Furthermore, for the purpose of enhancing the workability (wettability with a base material, and the like), a leveling agent (wetting agent) may be contained in the hydrophilic coating liquid composition of the present invention. Examples of the leveling agent include ordinary hydrocarbon-based surfactants and fluorine-based surfactants (anionic surfactants, cationic surfactants, nonionic surfactants, amphoteric surfactants). Among these, fluorine-based surfactants and non-ionic surfactants are preferred because effects are exerted even when a small amount thereof is added.

Specific examples of the fluorine-based surfactant include FTERGENTs (product name) available from NEOS COMPANY LIMITED described below.

Specifically, examples thereof include FTERGENT 100, FTERGENT 100C, FTERGENT 110, FTERGENT 150, FTERGENT 150CH, FTERGENT A-K, FTERGENT 501, FTERGENT 250, FTERGENT 251, FTERGENT 222F, FTERGENT 208G, FTERGENT 300, FTERGENT 310, FTERGENT 400SW, and the like.

Examples of the non-ionic surfactant include Surfynols (product name) available from Nissin Chemical Industry Co., Ltd. Specifically, examples thereof include Surfynol 104 series and the like.

A coating film of the present invention is obtained by performing wet coating with the hydrophilic coating liquid composition. That is, the coating film of the present invention is obtained by applying the hydrophilic coating liquid composition of the present invention on a base material and then curing the composition.

The hydrophilic coating liquid composition of the present invention can be applied to the hydrophilization of surfaces of substrates, sheets, films and fibers made of glass, plastics (polymethyl methacrylate, polyethylene terephthalate, polybutylene terephthalate, polyethylene naphthalate, ABS, polycarbonate, polystyrene, epoxy, unsaturated polyester, melamine, diallylphthalate, polyimide, urethane, nylon, polyethylene, polypropylene, a cycloolefin polymer, polyvinyl chloride, fluororesins (a polytetrafluoroethylene resin, a polychlorotrifluoroethylene resin, a polyvinylidene fluoride resin, a polyvinyl fluoride resin, a perfluoroalkoxy fluororesin, a tetrafluoroethylene/hexafluoropropylene copolymer resin, an ethylene/tetrafluoroethylene copolymer resin, an ethylene/chlorotrifluoroethylene copolymer resin, and the like), polybutadiene, polyisoprene, SBR, nitrile rubber, EPM, EPDM, epichlorohydrin rubber, neoprene rubber, polysulfide, butyl rubber, and the like), metals (iron, aluminum, stainless steel, titanium, copper, yellow brass, an alloy thereof, and the like), cellulose, a cellulose derivative, cellulose analogs (chitin, chitosan, porphyran, and the like), natural fibers (silk, cotton, and the like), or the like.

Moreover, for the purpose of enhancing the adhesiveness to a substrate and the like, as necessary, a primer may be used or surface activation treatments (treatments by a technique of heightening the surface energy on a base material surface) such as vacuum plasma, atmospheric pressure plasma, a corona discharge treatment, a flame treatment, an Itro treatment, ultraviolet ray irradiation, and an ozone treatment may be performed.

Examples of a method of applying a coating liquid composed of the hydrophilic coating liquid composition of the present invention include dip coating, spin coating, flow coating, spray coating, and the like.

The hydrophilic coating liquid composition is applied by the above-described applying method or the like and dried, after which a treatment with a substance (a catalyst, for example, basic substances: ammonia gas and the like) and the like that promote dehydration condensation for curing the coating film produced may be performed to enhance the mechanical properties and chemical properties of the coating film.

In the case of being cured only by a heat treatment, the heat treatment temperature usually lies within the range of room temperature to 300° C., preferably lies within the range of room temperature to 250° C., and especially preferably lies within the range of room temperature to 200° C.

The time period during which the heat treatment is performed usually lies within the range of 1 minute to 48 hours, preferably lies within the range of 3 minutes to 48 hours, and especially preferably lies within the range of 3 minutes to 24 hours.

Next, a method of performing dry coating with the betaine-based silicon compound according to [1] described above to form a coating film will be described.

The betaine-based silicon compound of the present invention can be used to perform dry coating by a dry process, namely, vacuum deposition, sputtering, ionized deposition, Ion Beam, CVD, or the like, on various subject base materials.

Examples of the vacuum deposition include resistance heating, high frequency induction heating, electron beam heating, arc discharge, laser ablation, molecular beam epitaxy, and the like.

Examples of the ionized deposition include DC ion plating, RF ion plating, hollow cathode discharge, activated reactive evaporation, cluster ion beam, and the like.

Examples of the sputtering include DC magnetron, AC magnetron, Dual magnetron, facing target, ion beam sputtering, ECR sputtering, and the like.

Examples of the Ion Beam include ion beam deposition, ion beam-assisted deposition, ion beam sputtering, and the like.

Examples of the CVD include plasma CVD, thermal CVD, photo-CVD, MOCVD, and the like.

### EXAMPLES

Hereinafter, the present invention will be described in more detail by way of examples, but the present invention is not limited to these examples.

### Preparation of Betaine-Based Silicon Compound (Examples 1 to 13)

### Example 1

Under an argon atmosphere, 60.2 g (290 mmol) of N,N-dimethylaminopropyltrimethoxysilane (available from Tokyo Chemical Industry Co., Ltd.) and 33.8 g (290 mmol) of sodium chloroacetate (available from NACALAI TESQUE, INC.) were dissolved in 300 ml of dehydrated ethanol, after which the solution was heated and refluxed for 24 hours. After the completion of the reaction, sodium chloride generated as a precipitate was removed by suction filtration to obtain 382.0 g of a solution in ethanol of a mixture of No. 1-1 and No. 1-3 which are the betaine-based silicon compounds of the present invention. (In this connection, the No. of a betaine-based silicon compound refers to the No. of the betaine-based silicon compound described above as a specific example. The same holds true for the following examples.)

After the removal of ethanol contained in the ethanol solution, a residue was subjected to measurement by infrared absorption spectrometry.

An absorption peak (1600 cm⁻¹) of the carbonyl group of the raw material (sodium chloroacetate) had disappeared, and an absorption peak (1628 cm⁻¹) of the carbonyl group of an aimed product was newly confirmed.

### Example 2

Under an argon atmosphere, 10.0 g (40.4 mmol) of 3-(triethoxysilyl)propyl isocyanate (available from Shin-Etsu Chemical Co., Ltd.) was added to 3.6 g (40.4 mmol) of dimethylaminoethanol (available from NACALAI TESQUE, INC.), and by causing the contents to react with each other for 48 hours at 90° C., 12.7 g of a compound (A) in which a dimethylaminoethyl group was bonded to a 3-(triethoxysilyl)propyl group through a carbamate bond was obtained.

In ¹H-NMR measurement, an absorption signal (3.30 ppm) of the proton of a carbon atom to which the isocyanate group of 3-(triethoxysilyl)propyl isocyanate being a raw material was bonded had disappeared, and an absorption signal (3.17 ppm) of the proton of a carbon atom to which the carbamate group was bonded of an aimed product was newly confirmed.

In 50 ml of dehydrated ethanol were dissolved 5.0 g (14.9 mmol) of the compound (A) and 1.80 g (15.4 mmol) of sodium chloroacetate (available from NACALAI TESQUE, INC.), after which the solution was heated and refluxed for 24 hours. After the completion of the reaction, sodium chloride generated as a precipitate and excess sodium chloroacetate were removed by suction filtration, and then, ethanol was removed to obtain 4.3 g of No. 1-11 which is the betaine-based silicon compound of the present invention.

The obtained betaine-based silicon compound of the present invention was subjected to measurement by infrared absorption spectrometry.

An absorption peak (1600 cm⁻¹) of the carbonyl group of the raw material (sodium chloroacetate) had disappeared, and an absorption peak (1631 cm⁻¹) of the carbonyl group of an aimed product was newly confirmed.

### Example 3

Under an argon atmosphere, 5.4 g (40.6 mmol) of 2-[2-(dimethylamino)ethoxy]ethanol (available from Tokyo Chemical Industry Co., Ltd.) and 10.0 g (40.4 mmol) of 3-(triethoxysilyl)propyl isocyanate (available from Shin-Etsu Chemical Co., Ltd.) were added, and by causing the contents to react with each other for 48 hours at 90° C., 14.3 g of a compound (B) in which a 2-[2-(dimethylamino)ethoxy]ethyl group was bonded to a 3-(triethoxysilyl)propyl group through a carbamate bond was obtained.

In ¹H-NMR measurement, an absorption signal (3.30 ppm) of the proton of a carbon atom to which the isocyanate group of 3-(triethoxysilyl)propyl isocyanate being a raw material was bonded had disappeared, and an absorption signal (3.17 ppm) of the proton bonded to a carbon atom to which the carbamate group was bonded of an aimed product was newly confirmed.

In 30 ml of dehydrated ethanol were dissolved 7.85 g (20.6 mmol) of the compound (B) and 2.41 g (20.7 mmol) of sodium chloroacetate (available from NACALAI TESQUE, INC.), after which the solution was heated and refluxed for 24 hours. After the completion of the reaction, sodium chloride generated as a precipitate and excess sodium chloroacetate were removed by suction filtration to obtain 39.3 g of a solution in ethanol of No. 1-19 which is the betaine-based silicon compound of the present invention.

After the removal of ethanol contained in the ethanol solution, a residue was subjected to measurement by infrared absorption spectrometry.

An absorption peak (1600 cm⁻¹) of the carbonyl group of the raw material (sodium chloroacetate) had disappeared, and an absorption peak (1640 cm⁻¹) of the carbonyl group of an aimed product was newly confirmed.

### Example 4

Under an argon atmosphere, 8.3 g (40.4 mmol) of 3-(triethoxysilyl)propyl isocyanate (available from Shin-Etsu Chemical Co., Ltd.) was added to 3.4 g (40.4 mmol) of 3-(dimethylamino)-1-propanol (available from Tokyo Chemical Industry Co., Ltd.), and by causing the contents to react with each other for 48 hours at 90° C., 10.1 g of a compound (C) in which a dimethylaminoethyl group was bonded to a 3-(triethoxysilyl)propyl group through a carbamate bond was obtained.

In ¹H-NMR measurement, an absorption signal (3.30 ppm) of the proton of a carbon atom to which the isocyanate group of 3-(triethoxysilyl)propyl isocyanate being a raw material was bonded had disappeared, and an absorption signal (3.17 ppm) of the proton of a carbon atom to which the carbamate group was bonded of an aimed product was newly confirmed.

In 30 ml of dehydrated methanol were dissolved 6.0 g (20.6 mmol) of the compound (C) and 2.41 g (20.7 mmol) of sodium chloroacetate (available from NACALAI TESQUE, INC.), after which the solution was heated and refluxed for 48 hours. After the completion of the reaction, sodium chloride generated as a precipitate and excess sodium chloroacetate were removed by suction filtration to obtain 39.3 g of a solution in methanol of No. 1-16 which is the betaine-based silicon compound of the present invention.

After the removal of methanol contained in the methanol solution, a residue was subjected to measurement by infrared absorption spectrometry.

An absorption peak (1600 cm⁻¹) of the carbonyl group of the raw material (sodium chloroacetate) had disappeared, and an absorption peak (1642 cm⁻¹) of the carbonyl group of an aimed product was newly confirmed.

### Example 5

Under an argon atmosphere, 328 mg (2 mmol) of azobisisobutyronitrile (available from NACALAI TESQUE, INC.) was dissolved in a mixture of 8.5 g (100 mmol) of dimethylallylamine (available from Tokyo Chemical Industry Co., Ltd.) and 19.6 g (100 mmol) of 3-mercaptopropyltrimethoxysilane (available from Shin-Etsu Chemical Co., Ltd.), the inside of the reaction system was replaced with argon gas bubbled through the solution, and then, the solution was heated and stirred for 24 hours at 80° C. to obtain 27.9 g of a compound (D) in which a 3-dimethylaminopropyl group was bonded to a 3-(trimethoxysilyl)propyl group through a thioether bond.

In ¹H-NMR measurement, disappearance of signals (5.11 to 5.21 and 5.78 to 5.93 ppm) attributed to protons of the allyl group of dimethylallylamine being a raw material was confirmed.

In 50 ml of dehydrated isopropyl alcohol were dissolved 10.0 g (35.6 mmol) of the compound (D) and 4.2 g (36.0 mmol) of sodium chloroacetate (available from NACALAI TESQUE, INC.), after which the solution was heated and refluxed for 24 hours. After the completion of the reaction, sodium chloride generated as a precipitate and excess sodium chloroacetate were removed by suction filtration to obtain 54.2 g of a solution in isopropyl alcohol of a mixture of No. 1-28 and No. 1-30 which are the betaine-based silicon compounds of the present invention.

After the removal of isopropyl alcohol contained in the isopropyl alcohol solution, a residue was subjected to measurement by infrared absorption spectrometry.

An absorption peak (1600 cm⁻¹) of the carbonyl group of the raw material (sodium chloroacetate) had disappeared, and an absorption peak (1634 cm⁻¹) of the carbonyl group of an aimed product was newly confirmed.

### Example 6

Under an argon atmosphere, 328 mg (2 mmol) of azobisisobutyronitrile (available from NACALAI TESQUE, INC.) was dissolved in a mixture of 14.3 g (100 mmol) of 2-(dimethylamino)ethyl acrylate (available from Tokyo Chemical Industry Co., Ltd.), 19.6 g (100 mmol) of 3-mercaptopropyltrimethoxysilane (available from Shin-Etsu Chemical Co., Ltd.), and 100 ml of dehydrated ethyl acetate, the inside of the reaction system was replaced with argon gas bubbled through the solution, and then, the solution was heated and stirred for 24 hours at 80° C., after which ethyl acetate was removed to obtain 34.2 g of a compound (E) in which an acrylic group of 2-(dimethylamino)ethyl acrylate was bonded to a 3-(trimethoxysilyl)propyl group through a thioether bond.

In ¹H-NMR measurement, disappearance of signals (5.80, 6.16, and 6.43 ppm) attributed to protons of the acrylic group of 2-(dimethylamino)ethyl acrylate being a raw material was confirmed.

In 60 ml of dehydrated ethyl alcohol were dissolved 10.0 g (29.5 mmol) of the compound (E) and 3.43 g (29.5 mmol) of sodium chloroacetate (available from NACALAI TESQUE, INC.), after which the solution was heated and refluxed for 24 hours. After the completion of the reaction, sodium chloride generated as a precipitate was removed by suction filtration to obtain 56.3 g of a solution in ethyl alcohol of a mixture of No. 1-34 and No. 1-36 which are the betaine-based silicon compounds of the present invention.

After the removal of ethyl alcohol contained in the ethyl alcohol solution, a residue was subjected to measurement by infrared absorption spectrometry.

An absorption peak (1600 cm⁻¹) of the carbonyl group of the raw material (sodium chloroacetate) had disappeared, and an absorption peak (1633 cm⁻¹) of the carbonyl group of an aimed product was newly confirmed.

### Example 7

Under an argon atmosphere, 328 mg (2 mmol) of azobisisobutyronitrile (available from NACALAI TESQUE, INC.) was dissolved in a mixture of 15.7 g (100 mmol) of 2-(dimethylamino)ethyl methacrylate (available from Wako Pure Chemical Industries, Ltd.), 19.6 g (100 mmol) of 3-mercaptopropyltrimethoxysilane (available from Shin-Etsu Chemical Co., Ltd.), and 100 ml of dehydrated ethyl acetate, the inside of the reaction system was replaced with argon gas bubbled through the solution, and then, the solution was heated and stirred for 24 hours at 80° C., after which ethyl acetate was removed to obtain 32.9 g of a compound (F) in which a methacrylic group of 2-(dimethylamino)ethyl methacrylate was bonded to a 3-(trimethoxysilyl)propyl group through a thioether bond.

In ¹H-NMR measurement, disappearance of signals (5.75 and 6.11 ppm) attributed to protons of the methacrylic group of 2-(dimethylamino)ethyl methacrylate being a raw material was confirmed.

In 60 ml of dehydrated ethyl alcohol were dissolved 10.0 g (28.3 mmol) of the compound (F) and 3.3 g (28.3 mmol) of sodium chloroacetate (available from NACALAI TESQUE, INC.), after which the solution was heated and refluxed for 24 hours. After the completion of the reaction, sodium chloride generated as a precipitate was removed by suction filtration to obtain 55.7 g of a solution in ethyl alcohol of a mixture of No. 1-37 and No. 1-39 which are the betaine-based silicon compounds of the present invention.

After the removal of ethyl alcohol contained in the ethyl alcohol solution, a residue was subjected to measurement by infrared absorption spectrometry.

An absorption peak (1600 cm⁻¹) of the carbonyl group of the raw material (sodium chloroacetate) had disappeared, and an absorption peak (1630 cm⁻¹) of the carbonyl group of an aimed product was newly confirmed.

### Example 8

Under an argon atmosphere, 328 mg (2 mmol) of azobisisobutyronitrile (available from NACALAI TESQUE, INC.) was dissolved in a mixture of 15.6 g (100 mmol) of N-[3-(dimethylamino)propyl]acrylamide (available from Wako Pure Chemical Industries, Ltd.), 19.6 g (100 mmol) of 3-mercaptopropyltrimethoxysilane (available from Shin-Etsu Chemical Co., Ltd.), and 100 ml of dehydrated ethyl acetate, the inside of the reaction system was replaced with argon gas bubbled through the solution, and then, the solution was heated and stirred for 24 hours at 80° C. under an argon atmosphere, after which ethyl acetate was removed to obtain 34.2 g of a compound (G) in which an acrylic group of N-[3-(dimethylamino)propyl]acrylamide was bonded to a 3-(trimethoxysilyl)propyl group through a thioether bond.

In ¹H-NMR measurement, disappearance of signals (5.60, 6.05, and 6.21 ppm) attributed to protons of the acrylic group of N-[3-(dimethylamino)propyl]acrylamide being a raw material was confirmed.

In 60 ml of dehydrated ethyl alcohol were dissolved 10.0 g (28.4 mmol) of the compound (G) and 3.31 g (28.4 mmol) of sodium chloroacetate (available from NACALAI TESQUE, INC.), after which the solution was heated and refluxed for 24 hours. After the completion of the reaction, sodium chloride generated as a precipitate was removed by suction filtration to obtain 59.8 g of a solution in ethyl alcohol of a mixture of No. 1-40 and No. 1-42 which are the betaine-based silicon compounds of the present invention.

After the removal of ethyl alcohol contained in the ethyl alcohol solution, a residue was subjected to measurement by infrared absorption spectrometry.

An absorption peak (1600 cm⁻¹) of the carbonyl group of the raw material (sodium chloroacetate) had disappeared, and an absorption peak (1634 cm⁻¹) of the carbonyl group of an aimed product was newly confirmed.

### Example 9

Under an argon atmosphere, 328 mg (2 mmol) of azobisisobutyronitrile (available from NACALAI TESQUE, INC.) was dissolved in a mixture of 17.0 g (100 mmol) of N-[3-(dimethylamino)propyl]methacrylamide (available from Tokyo Chemical Industry Co., Ltd.), 19.6 g (100 mmol) of 3-mercaptopropyltrimethoxysilane (available from Shin-Etsu Chemical Co., Ltd.), and 100 ml of dehydrated ethyl acetate, the inside of the reaction system was replaced with argon gas bubbled through the solution, and then, the solution was heated and stirred for 24 hours at 80° C. under an argon atmosphere, after which ethyl acetate was removed to obtain 35.6 g of a compound (H) in which a methacrylic group of N-[3-(dimethylamino)propyl]methacrylamide was bonded to a 3-(trimethoxysilyl)propyl group through a thioether bond.

In ¹H-NMR measurement, disappearance of signals (5.30 and 5.74 ppm) attributed to protons of the methacrylic group of N-[3-(dimethylamino)propyl]methacrylamide being a raw material was confirmed.

In 60 ml of dehydrated ethyl alcohol were dissolved 10.0 g (27.3 mmol) of the compound (H) and 3.18 g (27.3 mmol) of sodium chloroacetate (available from NACALAI TESQUE, INC.), after which the solution was heated and refluxed for 24 hours. After the completion of the reaction, sodium chloride generated as a precipitate was removed by suction filtration to obtain 54.2 g of a solution in ethyl alcohol of a mixture of No. 1-43 and No. 1-45 which are the betaine-based silicon compounds of the present invention.

After the removal of ethyl alcohol contained in the ethyl alcohol solution, a residue was subjected to measurement by infrared absorption spectrometry.

An absorption peak (1600 cm⁻¹) of the carbonyl group of the raw material (sodium chloroacetate) had disappeared, and an absorption peak (1635 cm⁻¹) of the carbonyl group of an aimed product was newly confirmed.

### Example 10

Under an argon atmosphere, 13.0 g (52.6 mmol) of 3-(triethoxysilyl)propyl isocyanate (available from Shin-Etsu Chemical Co., Ltd.) was added to 10.0 g (52.6 mmol) of N,N,N′-trimethyl-N′-(2-hydroxyethyl)-bis(2-aminoethylether) (available from Tokyo Chemical Industry Co., Ltd.), and by causing the contents to react with each other for 48 hours at room temperature, 22.3 g of a compound (I) in which a hydroxyethyl group of N,N,N′-trimethyl-N′-(2-hydroxyethyl)-bis(2-aminoethylether) was bonded to a 3-(triethoxysilyl)propyl group through a carbamate bond was obtained.

In ¹H-NMR measurement, an absorption signal (3.30 ppm) of the proton of a carbon atom to which the isocyanate group of 3-(triethoxysilyl)propyl isocyanate being a raw material was bonded had disappeared, and an absorption signal (3.16 ppm) of the proton of a carbon atom to which the carbamate group was bonded of an aimed product was newly confirmed.

In 40 ml of dehydrated ethanol were dissolved 10.0 g (22.9 mmol) of the compound (I) and 5.4 g (46.3 mmol) of sodium chloroacetate (available from NACALAI TESQUE, INC.), after which the solution was heated and refluxed for 24 hours. After the completion of the reaction, sodium chloride generated as a precipitate and excess sodium chloroacetate were removed by suction filtration to obtain 42.6 g of a solution in ethanol of No. 1-46 which is the betaine-based silicon compound of the present invention.

The obtained betaine-based silicon compound of the present invention was subjected to measurement by infrared absorption spectrometry.

An absorption peak (1600 cm⁻¹) of the carbonyl group of the raw material (sodium chloroacetate) had disappeared, and an absorption peak (1640 cm⁻¹) of the carbonyl group of an aimed product was newly confirmed.

### Example 11

Under an argon atmosphere, 12.35 g (50.0 mmol) of 3-(triethoxysilyl)propyl isocyanate (available from Shin-Etsu Chemical Co., Ltd.) was added to 5.1 g (50.0 mmol) of N,N-dimethyl-1,3-propanediamine (available from NACALAI TESQUE, INC.), and by causing the contents to react with each other for 48 hours at room temperature, 16.7 g of a compound (J) in which an N,N-dimethyl-1,3-propanediamino group was bonded to a 3-(triethoxysilyl)propyl group through a urea bond was obtained.

In ¹H-NMR measurement, an absorption signal (3.30 ppm) of the proton of a carbon atom to which the isocyanate group of 3-(triethoxysilyl)propyl isocyanate being a raw material was bonded had disappeared, and an absorption signal (3.14 ppm) of the proton of a carbon atom to which the urea group was bonded of an aimed product was newly confirmed.

In about 35 ml of dehydrated ethanol were dissolved 3.84 g (11.0 mmol) of the compound (J) and 1.28 g (11.0 mmol) of sodium chloroacetate (available from NACALAI TESQUE, INC.), after which the solution was heated and refluxed for 24 hours. After the completion of the reaction, sodium chloride generated as a precipitate and excess sodium chloroacetate were removed by suction filtration to obtain 40.6 g of a solution in ethanol of No. 1-23 which is the betaine-based silicon compound of the present invention.

After the removal of ethanol contained in the ethanol solution, a residue was subjected to measurement by infrared absorption spectrometry.

An absorption peak (1600 cm⁻¹) of the carbonyl group of the raw material (sodium chloroacetate) had disappeared, and an absorption peak (1643 cm⁻¹) of the carbonyl group of an aimed product was newly confirmed.

### Example 12

Under an argon atmosphere, 24.7 g (50.0 mmol) of 3-(triethoxysilyl)propyl isocyanate (available from Shin-Etsu Chemical Co., Ltd.) was added to 5.96 g (50.0 mmol) of monomethyl diethanolamine (available from NACALAI TESQUE, INC.), and by causing the contents to react with each other for 48 hours at 90° C., 29.7 g of a compound (K) in which a hydroxyl group of monomethyl diethanolamine was bonded to a 3-(triethoxysilyl)propyl group through a carbamate bond was obtained.

In ¹H-NMR measurement, an absorption signal (3.30 ppm) of the proton of a carbon atom to which the isocyanate group of 3-(triethoxysilyl)propyl isocyanate being a raw material was bonded had disappeared, and an absorption signal (3.15 ppm) of the proton of a carbon atom to which the carbamate group was bonded of an aimed product was newly confirmed.

In about 40 ml of dehydrated ethanol were dissolved 9.5 g (15.5 mmol) of the compound (K) and 1.89 g (16.2 mmol) of sodium chloroacetate (available from NACALAI TESQUE, INC.), after which the solution was heated and refluxed for 24 hours. After the completion of the reaction, sodium chloride generated as a precipitate and excess sodium chloroacetate were removed by suction filtration to obtain 44.8 g of a solution in ethanol of No. 1-47 which is the betaine-based silicon compound of the present invention.

After the removal of ethanol contained in the ethanol solution, a residue was subjected to measurement by infrared absorption spectrometry.

An absorption peak (1600 cm⁻¹) of the carbonyl group of the raw material (sodium chloroacetate) had disappeared, and an absorption peak (1726 cm⁻¹) of the carbonyl group of an aimed product was newly confirmed.

### Example 13

Under an argon atmosphere, 12.4 g (50.4 mmol) of 3-(triethoxysilyl)propyl isocyanate (available from Shin-Etsu Chemical Co., Ltd.) was added to 2.50 g (16.8 mmol) of triethanolamine (available from NACALAI TESQUE, INC.), and by causing the contents to react with each other for 48 hours at 90° C., 13.6 g of a compound (L) in which a hydroxyl group of triethanolamine was bonded to a 3-(triethoxysilyl)propyl group through a carbamate bond was obtained.

In ¹H-NMR measurement, an absorption signal (3.30 ppm) of the proton of a carbon atom to which the isocyanate group of 3-(triethoxysilyl)propyl isocyanate being a raw material was bonded had disappeared, and an absorption signal (3.15 ppm) of the proton of a carbon atom to which the carbamate group was bonded of an aimed product was newly confirmed.

In about 40 ml of dehydrated ethanol were dissolved 13.8 g (15.5 mmol) of the compound (L) and 1.89 g (16.2 mmol) of sodium chloroacetate (available from NACALAI TESQUE, INC.), after which the solution was heated and refluxed for 24 hours. After the completion of the reaction, sodium chloride generated as a precipitate and excess sodium chloroacetate were removed by suction filtration to obtain 44.8 g of a solution in ethanol of No. 1-48 which is the betaine-based silicon compound of the present invention.

After the removal of ethanol contained in the ethanol solution, a residue was subjected to measurement by infrared absorption spectrometry.

An absorption peak (1600 cm⁻¹) of the carbonyl group of the raw material (sodium chloroacetate) had disappeared, and an absorption peak (1724 cm⁻¹) of the carbonyl group of an aimed product was newly confirmed.

### Preparation of Surface-Active Silane Coupling Agent (Synthesis Examples 1 to 3)

### Synthesis Example 1

(1) By causing 7.57 g of a surfactant available from Sanyo Chemical Industries, Ltd. (BEAULIGHT LCA-H, polyoxyethylene lauryl ether acetic acid, Acid Value: 107) and 3.4 g of 3-glycidoxypropyltrimethoxysilane to react with each other for 2 days at 100° C. under an argon atmosphere, 10.3 g of a surface-active silane coupling agent (M) in which the BEAULIGHT LCA-H and 3-glycidoxypropyltrimethoxysilane were bonded to each other through an ester bond was obtained. In ¹H-NMR measurement, disappearance of absorption signals (2.62, 2.80, and 3.16 ppm) attributed to protons on the epoxy ring of 3-glycidoxypropyltrimethoxysilane being a raw material was confirmed.

### Synthesis Example 2

By causing 20.2 g of a surfactant available from Sanyo Chemical Industries, Ltd. (EMULMIN L-90-S, an ethylene oxide adduct of dodecyl alcohol, Hydroxyl Value: 98.3) and 8.4 g of 3-glycidoxypropyltrimethoxysilane to react with each other for 2 days at 100° C. under an argon atmosphere with the use of 0.1 g of p-toluenesulfonic acid as a catalyst, 28.1 g of a surface-active silane coupling agent (N) in which the EMULMIN L-90-S and 3-glycidoxypropyltrimethoxysilane were bonded to each other through an ether bond was obtained. In ¹H-NMR measurement, disappearance of absorption signals (2.62, 2.80, and 3.16 ppm) attributed to protons on the epoxy ring of 3-glycidoxypropyltrimethoxysilane being a raw material was confirmed.

### Synthesis Example 3

Under an argon atmosphere, 4.33 g (17.5 mmol) of 3-(triethoxysilyl)propyl isocyanate (available from Shin-Etsu Chemical Co., Ltd.) was added to 10.0 g of polyoxyethylene lauryl ether (available from Sanyo Chemical Industries, Ltd., trade name: EMULMIN L90-S, a product which is prepared by addition reaction of about 9 ethylene oxide molecules with lauryl alcohol and has a hydroxyl value of 98.3), and by causing the contents to react with each other for 48 hours at 90° C., 14.3 g of a surface-active silane coupling agent (O) was obtained.

It was confirmed by ¹H-NMR that a chemical shift attributed to the methylene group at the α-position of the isocyanate group of 3-(triethoxysilyl)propyl isocyanate was shifted from 3.29 ppm to 3.16 ppm.

### Preparation of Blocked Isocyanate Compound

### Synthesis Example 4

In 100 ml of dehydrated ethyl acetate were dissolved 4.81 g (50.0 mmol) of 3,5-dimethylpyrazole and 12.35 g (50.0 mmol) of 3-isocyanatopropyltriethoxysilane, and the solution was stirred for 3 days at room temperature. After the completion of the reaction, ethyl acetate was removed to obtain 16.8 g of a blocked isocyanate compound (P) in which the isocyanate group of 3-isocyanatopropyltriethoxysilane was blocked with 3,5-dimethylpyrazole.

### Preparation of Metal Oxide Sol (Synthesis Examples 5 to 7)

### Synthesis Example 5

In 30 g of ethanol was dissolved 1.0 g (5.1 mmol) of 3-(trimethoxysilyl)propane-1-thiol (JNC CORPORATION), after which the solution was added with 6.0 g of organo silica sol (available from Nissan Chemical Industries, Ltd., a 30% isopropanol solution) and 6.5 g of water to be heated and refluxed for 24 hours. After being cooled, the liquid was added with 3.5 g (30.8 mmol) of hydrogen peroxide water (available from Santoku Chemical Industries Co., Ltd., an aqueous 30% solution) to be heated and refluxed for 24 hours. After the completion of the reaction, after being cooled to room temperature, the reaction liquid was added with an aqueous solution prepared by dissolving 0.214 g (5.1 mmol) of lithium hydroxide monohydrate in a small amount of water to be neutralized therewith, and 50.0 g of a solution in ethanol containing isopropanol silica sol modified with an LiOSO₂—CH₂CH₂CH₂Si(—O—)₃ group was obtained.

### Synthesis Example 6

In 36 g of ethanol were dissolved 1.0 g (5.1 mmol) of 3-(trimethoxysilyl)propane-1-thiol (JNC CORPORATION) and 0.4 g of the compound (M) synthesized in Synthesis Example 1, after which the solution was added with 6.0 g of organo silica sol (available from Nissan Chemical Industries, Ltd., a 30% isopropanol solution) and 6.5 g (361 mmol) of water to be heated and refluxed for 24 hours. After being cooled, the liquid was added with 3.5 g (30.8 mmol) of hydrogen peroxide water (available from Santoku Chemical Industries Co., Ltd., an aqueous 30% solution) to be heated and refluxed for 24 hours. After the completion of the reaction, the reaction liquid was cooled to room temperature and added with an aqueous solution prepared by dissolving 0.214 g (5.1 mmol) of lithium hydroxide monohydrate in a small amount of water to be neutralized therewith, and 50.0 g of a solution in ethanol containing isopropanol silica sol modified with an LiOSO₂—CH₂CH₂CH₂Si(—O—)₃ group and a group in which the BEAULIGHT LCA-H and 3-glycidoxypropyltrimethoxysilane were bonded to each other through an ester bond was obtained.

### Synthesis Example 7

With 44.0 g of ethanol was diluted 6.0 g of organo silica sol (available from Nissan Chemical Industries, Ltd., a 30% isopropanol solution) to obtain 50.0 g of a solution in ethanol containing non-modified isopropanol silica sol.

### [Preparation of Hydrophilic Coating Liquid Composition]

Each of the solutions in ethanol of the betaine-based silicon compound obtained in Examples 1 to 13, water, a metal alkoxide, each of the surface-active silane coupling agents obtained in Synthesis Examples 1 to 3, the blocked isocyanate compound obtained in Synthesis Example 4, each of the respective kinds of metal oxide sol obtained in Synthesis Examples 5 to 7, and 35% hydrogen peroxide water in blending amounts shown in Table 1 were mixed to be heated and refluxed for 24 hours. The obtained ethanol solution was diluted 10 times with ethanol to prepare a treatment liquid (hydrophilic coating liquid composition).

TABLE 1

| | Ethanol | | | Other |
|---|---|---|---|---|
| Example No. | Solution (g) | Ethanol (g) | Water (g) | Component(s) (g) |
| 1 | 6.35 | 37.15 | 6.5 | — |
| 1-2 | 6.35 | 34.15 | 6.5 | 3.0 |
| 1-3 | 6.35 | 37.53 | 5.7 | 0.42 |
| 1-4 | 6.35 | 37.49 | 5.7 | 0.46 |
| 1-5 | 6.35 | 37.15 | 5.7 | 0.80 |
| 1-6 | 6.35 | 36.75 | 6.5 | 0.4 |
| 1-7 | 6.35 | 36.75 | 6.5 | 0.4 |
| 1-8 | 6.35 | 36.75 | 6.5 | 0.4 |
| 1-9 | 6.35 | 36.35 | 6.5 | 0.4, 0.4 |
| 1-10 | 1.25 | 37.50 | 10.0 | 1.25 |
| 1-11 | 1.25 | 37.50 | 10.0 | 1.25 |
| 1-12 | 1.25 | 37.50 | 10.0 | 1.25 |
| 1-13 | 2.50 | 37.30 | 10.0 | 0.1, 0.1 |
| 2 | 0.99 | 45.76 | 3.25 | — |
| 3 | 9.52 | 33.98 | 6.5 | — |
| 3-2 | 9.52 | 33.58 | 6.5 | 0.4 |
| 4 | 9.73 | 33.77 | 6.5 | — |
| 4-2 | 9.73 | 33.37 | 6.5 | 0.4 |
| 5 | 7.60 | 35.90 | 6.5 | — |
| 5-2 | 7.60 | 33.90 | 6.5 | 2.0 |
| 6 | 10.00 | 33.50 | 6.5 | — |
| 6-2 | 10.00 | 31.50 | 6.5 | 2.0 |
| 7 | 9.84 | 33.66 | 6.5 | — |
| 8 | 10.53 | 32.97 | 6.5 | — |
| 9 | 10.65 | 32.85 | 6.5 | — |
| 9-2 | 10.65 | 30.85 | 6.5 | 2.0 |
| 10 | 9.29 | 34.21 | 6.5 | — |
| 11 | 18.4 | 25.1 | 6.5 | — |
| 12 | 3.61 | 39.79 | 6.5 | 0.1 |
| 13 | 14.4 | 29.0 | 6.5 | 0.1 |

### Supplementary Explanations for Respective Examples (the Same Holds True for Table 2)

Example 1-2: TEOS (tetraethoxysilane) was added to the compound (ethanol solution) of Example 1.
Example 1-3: 3-Aminopropyltrimethoxysilane was added to the compound (ethanol solution) of Example 1.
Example 1-4: 3-Mercaptopropyltrimethoxysilane was added to the compound (ethanol solution) of Example 1.
Example 1-5: The compound (P) of Synthesis Example 4 was added to the compound (ethanol solution) of Example 1.
Example 1-6: The compound (M) of Synthesis Example 1 was added to the compound (ethanol solution) of Example 1.
Example 1-7: The compound (N) of Synthesis Example 2 was added to the compound (ethanol solution) of Example 1.
Example 1-8: The compound (O) of Synthesis Example 3 was added to the compound (ethanol solution) of Example 1.
Example 1-9: The compounds (M) and (P) of Synthesis Examples 1 and 4 were added to the compound (ethanol solution) of Example 1.
Example 1-10: To the ethanol solution obtained in Example 1-6, 1.25 g of the ethanol solution obtained in Synthesis Example 5 was added and used directly without being diluted 10 times with ethanol.
Example 1-11: To the ethanol solution obtained in Example 1-6, 1.25 g of the ethanol solution obtained in Synthesis Example 6 was added and used directly without being diluted 10 times with ethanol.
Example 1-12: To the ethanol solution obtained in Example 1-6, 1.25 g of the ethanol solution obtained in Synthesis Example 7 was added and used directly without being diluted 10 times with ethanol.
Example 1-13: To the ethanol solution obtained in Example 1-6, 0.1 g of a sol solution of THRULYA (available from JGC Catalysts and Chemicals Ltd.) and 0.1 g of an IPA-ST sol solution (available from Nissan Chemical Industries, Ltd.) were added and used directly without being diluted 10 times with ethanol.
Example 2: Only the betaine-based silicon compound was used.
Example 3-2: The compound (M) of Synthesis Example 1 was added to the compound of Example 3.
Example 4-2: The compound (M) of Synthesis Example 1 was added to the compound of Example 4.
Example 5-2: Hydrogen peroxide water was added to the compound of Example 5.
Example 6-2: Hydrogen peroxide water was added to the compound of Example 6.
Example 9-2: Hydrogen peroxide water was added to the compound of Example 9.
Example 12: The compound (M) of Synthesis Example 1 was added to the compound of Example 12.
Example 13: The compound (M) of Synthesis Example 1 was added to the compound of Example 13.

### [Hydrophilicity Evaluation Results]

A microscope slide {76 mm, 26 mm, 1.2 mm; a slide being immersed for 24 hours in a saturated solution of sodium hydroxide in 2-propanol, washed with water, and dried (60° C., 2 hours)} was immersed in a treatment liquid (hydrophilic coating liquid composition) and taken out, after which the slide was subjected to liquid draining and then subjected to a heating treatment for 1 hour at 130° C. to obtain a surface-modified microscope slide.

In this context, in Example 1-9, a polycarbonate plate of the same size as the microscope slide was used to obtain a surface-modified polycarbonate plate.

With a contact angle measuring apparatus (Kyowa Interface Science Co., Ltd., DROP MASTER 500, Droplet Amount: 2 μL, Measurement Interval: 1000 ms, Number of Times of Measurement: 30 times), five arbitrary points on the surface of the surface-modified microscope slide were measured for the contact angle (degree) to calculate an average value. The results were shown in Table 2.

A piece of surface-modified glass, which was measured for the contact angle and evaluated for the defogging properties, was immersed for 30 minutes in pure water and then dried in air. With the above-described contact angle measuring apparatus, the piece of surface-modified glass was measured for the contact angle (degree) under the same measurement condition as above. The results were shown in Table 2.

### [Defogging Properties Evaluation Results]

With regard to test pieces obtained in the respective Examples, each substrate was placed above a hot water bath at 70° C. to be evaluated for the defogging performance (whether fogging due to water vapor is observed or not). The results were shown in Table 2.

TABLE 2

| | Contact Angle | Contact Angle (degree) | Defogging |
|---|---|---|---|
| Example No. | (degree) | (after immersion) | Properties |
| 1 | 4.5 | 6.7 | ∘ |
| 1-2 | 15.0 | 15.8 | ∘ |
| 1-3 | 12.9 | 13.1 | ∘ |
| 1-4 | 9.1 | 11.5 | ∘ |
| 1-5 | 6.5 | 7.3 | ∘ |
| 1-6 | 4.1 | 6.5 | ∘ |
| 1-7 | 5.0 | 5.9 | ∘ |
| 1-8 | 6.3 | 8.2 | ∘ |
| 1-9 | 6.8 | 9.9 | ∘ |
| 1-10 | 5.9 | 8.1 | ∘ |
| 1-11 | 4.5 | 6.2 | ∘ |
| 1-12 | 6.2 | 7.5 | ∘ |
| 1-13 | 7.2 | 8.9 | ∘ |
| 2 | 6.8 | 8.0 | ∘ |
| 3 | 5.1 | 9.1 | ∘ |
| 3-7 | 3.9 | 6.5 | ∘ |
| 4 | 4.8 | 5.3 | ∘ |
| 4-2 | 5.2 | 6.1 | ∘ |
| 5 | 6.5 | 7.4 | ∘ |
| 5-2 | 5.3 | 6.0 | ∘ |
| 6 | 4.5 | 8.1 | ∘ |
| 6-2 | 5.1 | 6.5 | ∘ |
| 7 | 6.8 | 9.7 | ∘ |
| 8 | 4.3 | 4.9 | ∘ |
| 9 | 5.6 | 6.2 | ∘ |
| 9-2 | 4.9 | 8.3 | ∘ |
| 10 | 3.2 | 4.5 | ∘ |
| 11 | 6.9 | 7.0 | ∘ |
| 12 | 4.5 | 7.8 | ∘ |
| 13 | 6.2 | 8.1 | ∘ |
| Microscope | 46.2 | — | x |
| Slide | | | |
| Polycarbonate | 86.7 | — | x |

### Explanation of Defogging Properties: ◯ (With Defogging Properties), x (With No Defogging Properties)

As apparent from Table 2, the betaine-based silicon compound of the present invention is very useful for hydrophilization of a base material, is high in durability, and is also useful for imparting defogging properties.

### INDUSTRIAL APPLICABILITY

For example, the betaine-based silicon compound and hydrophilic coating liquid composition of the present invention are useful for coating a surface of base materials such as a glass plate, a medical material, a biocompatible material, a cosmetic material, an optical material (eyeglasses, a camera lens, and the like), a resin film, and a resin sheet to impart hydrophilicity to the surface because the betaine-based silicon compound of the present invention has a great hydrophilization effect and a great anti-fogging effect, is coatable thereon, and is inexpensively producible. That is, the coating film of the present invention is less liable to be separated from a base material even when brought into contact with water and has excellent hydrophilicity and defogging properties.

1-8. (canceled)

9. A betaine-based silicon compound represented by the following formula (1):
{X¹₃₋ₘ(CH₃)ₘSi—R¹—(Y¹—R²)ₙ}ₒ—N⁺(R³)ₚ(R⁴)_{q}—Y²COO⁻ (1)
{wherein X¹ represents an alkoxy group with 1 to 5 carbon atoms or a halogen atom, X¹s may be identical to or different from each other; m represents 0 or 1; R¹ represents an alkylene group with 1 to 5 carbon atoms; Y¹ represents —NHCOO—, —NHCONH—, —S—, or —SO₂—; n represents 0 or 1; R² represents an alkylene group with 1 to 10 carbon atoms which may contain an ether bond, an ester bond, or an amide bond or —CH₂CH₂N⁺(CH₃)(Y²COO⁻)CH₂CH₂OCH₂CH₂—; o represents 1, 2, or 3; R³ and R⁴ represent alkyl groups with 1 to 5 carbon atoms which may be identical to or different from each other, Y² represents —CH₂—, —CH₂CH₂—, or —CH₂C₆H₄—; p and q each represent 0 or 1; provided that o+p+q equals 3}.

10. A hydrolysis product of the betaine-based silicon compound according to claim 9.

11. A hydrophilic coating liquid composition composed of a solution containing the betaine-based silicon compound according to claim 9 and/or a hydrolysis product of the betaine-based silicon compound thereof.

12. The hydrophilic coating liquid composition according to claim 11, wherein a surface-active silane coupling agent being a reaction product between a surfactant represented by the following formula (2) and a silane coupling agent having a functional group reactive with an active hydrogen group in the formula (2) and/or a hydrolyzate thereof are/is further contained in the solution:
R⁵—X²—(CH₂CH₂O)ᵣ—Y³ (2)
{wherein R⁵ is an alkyl group with 1 to 20 carbon atoms (the alkyl group may contain a benzene ring and a double bond); X² is —O—, —COO—, or —CONH—; r is a natural number of 1 to 30; and Y³ represents a hydrogen atom or —CH₂COOH}.

13. The hydrophilic coating liquid composition according to claim 11, further containing at least one kind selected from the group of a metal alkoxide, a metal alkoxide oligomer, a metal oxide sol, and a metal oxide.

14. The hydrophilic coating liquid composition according to claim 12, further containing at least one kind selected from the group of a metal alkoxide, a metal alkoxide oligomer, a metal oxide sol, and a metal oxide.

15. A coating film obtained by applying the hydrophilic coating liquid composition according to claim 11 and then curing the composition.

16. A coating film obtained by applying the hydrophilic coating liquid composition according to claim 12 and then curing the composition.

17. A coating film obtained by applying the hydrophilic coating liquid composition according to claim 13 and then curing the composition.

18. A coating film obtained by performing dry coating with the betaine-based silicon compound according to claim 9.

19. A method for producing the betaine-based silicon compound according to claim 9, the method comprising the step of causing a silane coupling agent represented by the following formula (3) and an alkali metal salt of a haloacetic acid compound represented by the following formula (4) to react with each other:
{X¹₃₋ₘ(CH₃)ₘSi—R¹—(Y¹—R^{2′})ₙ}ₒ—N(R³)ₚ(R⁴)_{q} (3)
{wherein X¹ represents an alkoxy group with 1 to 5 carbon atoms or a halogen atom, X¹s may be identical to or different from each other; m represents 0 or 1; R¹ represents an alkylene group with 1 to 5 carbon atoms; Y¹ represents —NHCOO—, —NHCONH—, —S—, or —SO₂—; n represents 0 or 1; R^{2′} represents an alkylene group with 1 to 10 carbon atoms which may contain an ether bond, an ester bond, or an amide bond or —CH₂CH₂N(CH₃)CH₂CH₂OCH₂CH₂—; o represents 1, 2, or 3; R³ and R⁴ represent alkyl groups with 1 to 3 carbon atoms which may be identical to or different from each other; p and q each represent 0 or 1; provided that o+p+q equals 3};
Z¹—Y⁵COOM (4)
{wherein Z¹ represents a halogen atom; Y⁵ represents —CH₂—, —CH₂CH₂—, or —CH₂C₆H₄—; and M represents an alkali metal atom}.
